(19) United States
(12) Patent Application Publication
(10) Pub. No.: US 2012/0207442 A1
(43) Pub. Date: Aug. 16, 2012

(54) REPRODUCING APPARATUS, REPRODUCING METHOD AND PROGRAM

(75) Inventor: Makoto SATO, Sagamihara-shi (JP)

(73) Assignee: JVC KENWOOD CORPORATION, Yokohama-shi (JP)

(21) Appl. No.: 13/396,315

(22) Filed: Feb. 14, 2012

(30) Foreign Application Priority Data
Feb. 15, 2011 (JP) 2011-029911

(51) Int. Cl. H04N 5/775

(52) U.S. Cl. 386/230; 386/E05.07

(57) ABSTRACT

A reproducing apparatus includes: a storage unit; a display control unit; a position determining unit; and a reproduction control unit. The storage unit stores information of each of a plurality of contents. The display control unit controls to display, on a display unit, content identification images corresponding to the plurality of contents respectively. The position determining unit determines a reproducing position for the content based on a designating position for a display range of the content identification images which is designated when any one of the content identification image is designated. The reproduction control unit reproduces the determined content from the determined reproducing position.

### CROSS-REFERENCE TO RELATED APPLICATIONS

The present application claims priority to and incorporates by reference the entire contents of Japanese Patent Application No. 2011-029911 filed in Japan on Feb. 15, 2011.

### BACKGROUND OF THE INVENTION

1. Field of the Invention

The present invention relates to a reproducing apparatus, a reproducing method and a program.

2. Description of the Related Art

There is known a reproducing apparatus for selecting and determining an arbitrary one of a plurality of contents by a user and reproducing content information. However, there are plurality of contents, and therefore, a long time is required for a user to find out a desired one of the contents in some cases. For example, Japanese. Laid-open Patent Publication No. 2006-344342 discloses a method of partially reproducing content information selected from among a plurality of contents by a user and causing the user to hear the partially reproduced content information, thereby efficiently finding out the content desired by the user.

With the structure disclosed in the Japanese Laid-open Patent Publication No. 2006-344342, however, a position (a place) in which content information selected by a user is partially reproduced is predetermined, and the user cannot decide a type of the content reproduced partially depending on the content. Therefore, a new method capable of efficiently finding out the content desired by the user has been demanded.

### SUMMARY OF THE INVENTION

It is an object of the present invention to at least partially solve the problems in the conventional technology.

According to an aspect of the present invention a reproducing apparatus includes: a storage unit that stores information of each of a plurality of contents; a display control unit that controls to display, on a display unit, content identification images corresponding to the plurality of contents respectively; a position determining unit that determines a reproducing position for the content based on a designating position for a display range of the content identification images which is designated when any one of the content identification image is designated; and a reproduction control unit that reproduces the determined content from the determined reproducing position.

According to another aspect of the present invention, a reproducing method includes: storing information of each of a plurality of contents; controlling to display, on a display unit, content identification images corresponding to the plurality of contents respectively; determining a reproducing position for the content based on a designating position for a display range of any one of the content identification images which is designated when the content identification image is designated; and reproducing the determined content from the determined reproducing position.

According to still another aspect of the present invention, a computer-readable recording medium that stores therein a computer program for outputting information, the computer program causing a computer to execute: controlling to display, on a display unit, a content identification image corresponding to each of a plurality of contents; determining a reproducing position for the content based on a designating position for a display range of any one of the content identification images which is designated when the content identification image is designated; and reproducing the determined content from the determined reproducing position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a structure of a reproducing apparatus according to a first embodiment;

FIG. 2 is a flow chart for explaining a reproduction processing;

FIG. 3A is a diagram illustrating an example of a display of a screen in a normal reproducing mode;

FIG. 3B is a diagram illustrating an example of a display of a screen in a partial reproducing mode;

FIG. 4 is a diagram illustrating an example of a display of a content identification image in a designated content;

FIG. 5 is a diagram for explaining a method of determining a reproduction starting time;

FIG. 6 is a diagram for explaining a method of changing the reproduction starting time;

FIG. 7 is a diagram illustrating a structure of a reproducing apparatus according to a second embodiment;

FIG. 8 is a flow chart for explaining a reproduction processing according to the second embodiment; and

FIG. 9 is a diagram for explaining a method of determining a reproduction time.

### DETAILED DESCRIPTION OF THE PREFERRED EMBODIMENTS

Embodiments according to the present invention will be described below. The embodiments which will be described below are intended for explanation, and the scope of the present invention is not restricted thereto. Accordingly, the skilled in the art can employ an embodiment in which respective elements or all elements are replaced with equivalents, and these embodiments are also included in the scope of the present invention.

### First Embodiment

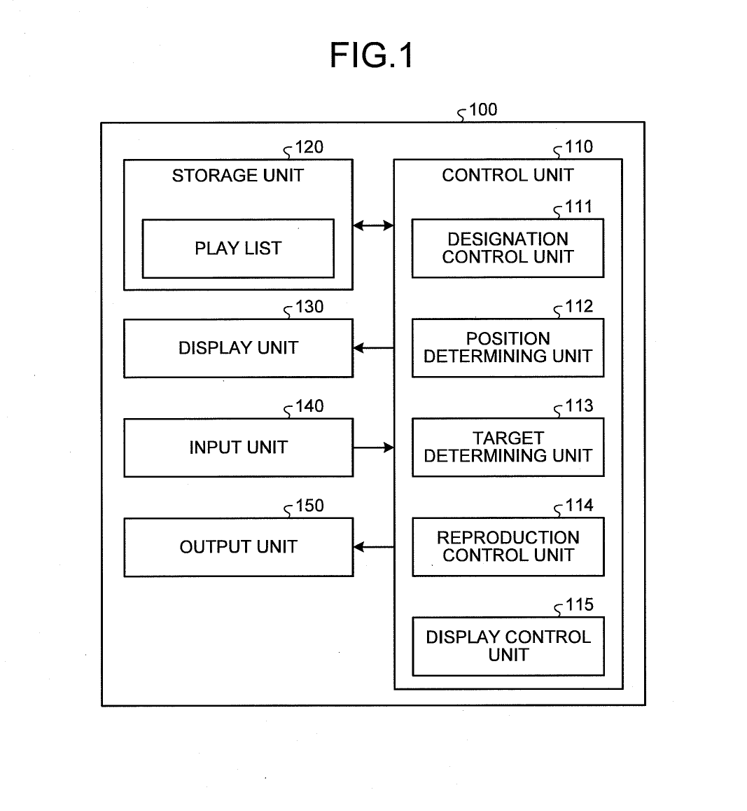

A reproducing apparatus according to a first embodiment of the present invention serves to reproduce multimedia information: (for example, phonetic information, video information, character information and their complex information), thereby offering the information to a user. As illustrated in FIG. 1, a reproducing apparatus 100 includes: a control unit 110; a storage unit 120; a display unit 130; an input unit 140; and an output unit 150.

The control unit 110 includes an arithmetic processing circuit such as a CPU (Central Processing Unit), a RAM (Random Access Memory) serving as a work area, various drivers, and the like, and controls each unit of the reproducing apparatus 100 and executes each processing, which will be described below, based on a predetermined operation program stored in the storage unit 120. As illustrated in FIG. 1, the control unit 110 includes a designation control unit 111, a position determining unit 112, a target determining unit 113, a reproduction control unit 114, and a display control unit 115. Moreover, respective structures in the reproducing apparatus 100 are connected to the control unit 110, and data is transmitted/received between the respective structures through the control unit 110.

The designation control unit 111 controls to designate any one of the contents before a content to be reproduced is determined. The content represents information constituted by a piece of music or a video, for example. The designation control unit 111 controls to designate one of the contents based on an input instruction from a user (the input unit 140).

The position determining unit 112 determines a reproducing position in which the content designated by the designation control unit 111 is partially reproduced. A method of determining a reproducing position for the content will be described below.

The target determining unit 113 determines, as a reproducing target, any one of the contents which is to be partially reproduced and for which a reproducing position is determined. The determination herein represents an action for selecting the content designated by the designation control unit 111 as the content to be partially reproduced. Moreover, the partial reproduction herein represents an action for reproducing a part (for example, one minute) of the content constituted by a predetermined time (for example, five minutes). When the content to be a reproducing target is determined by the target determining unit 113, the content is partially reproduced.

The reproduction control unit 114 controls to reproduce the content determined as the reproducing target by the target determining unit 113. The content controlled to be reproduced is output (reproduced) by the display unit 130 or the output unit 150.

The display control unit 115 controls to display a predetermined image on the display unit 130.

The storage unit 120 includes a predetermined storage device such as an ROM (Read Only Memory) or a flash memory, and stores necessary data for executing each processing, data acquired or generated by executing each processing, and the like, in addition to an operation program (an application) to be executed by the control unit 110. A processing to be carried out by the reproducing apparatus 100 is implemented by executing the operation program stored in the storage unit 120 through the control unit 110.

Moreover, the storage unit 120 stores a play list in which a plurality of contents is determined in predetermined order (for example, the Japanese alphabetical order, recording order, and order determined by a user) and a plurality pieces of multimedia information constituted by a music or a video. Each of the multimedia information includes title information about a piece of music or a video, phonetic information, video information, recording time (sound recording and picture recording time) information, and the like.

The display unit 130 includes an LCD of a dot matrix type or an organic EL panel, a driver circuit, and the like, for example, and displays an arbitrarily selected image. The display unit 130 displays a content identification image corresponding to each one of the plurality of contents, and prompts a user to carry out an operation. The content identification image herein expresses a content to be a reproducing target in a form of picture, marks, characters, or the like over an operation screen. The content identification image is displayed in a plurality of lists which functions as the play list. The user selects the content identification image displaying what is contained in the content with reference to the displayed play list, thereby designating and determining the content. Moreover, the display unit 130 displays a position in which a partial reproduction is started (a reproduction starting time) for the content determined by the position determining unit 112.

The input unit 140 includes various keys (for example, a four-direction key [a cross key] and a cursor key) for accepting a designation from the user, a button, a touch panel, or the like, and inputs various designations and data to be transmitted to the control unit 110. The input unit 140 accepts, from the user, an input designation for designating any one of the plurality of contents and an input designation for determining the designated content as a reproducing target, and inputs the input designation to the control unit 110.

The output unit 150 is constituted by a speaker, or the like, for example, and converts the reproduced multimedia information into speech signals and video signals, thereby outputting a speech and a video.

Next, the reproducing operation of the reproducing apparatus 100 according to the first embodiment will be described with reference to the drawings.

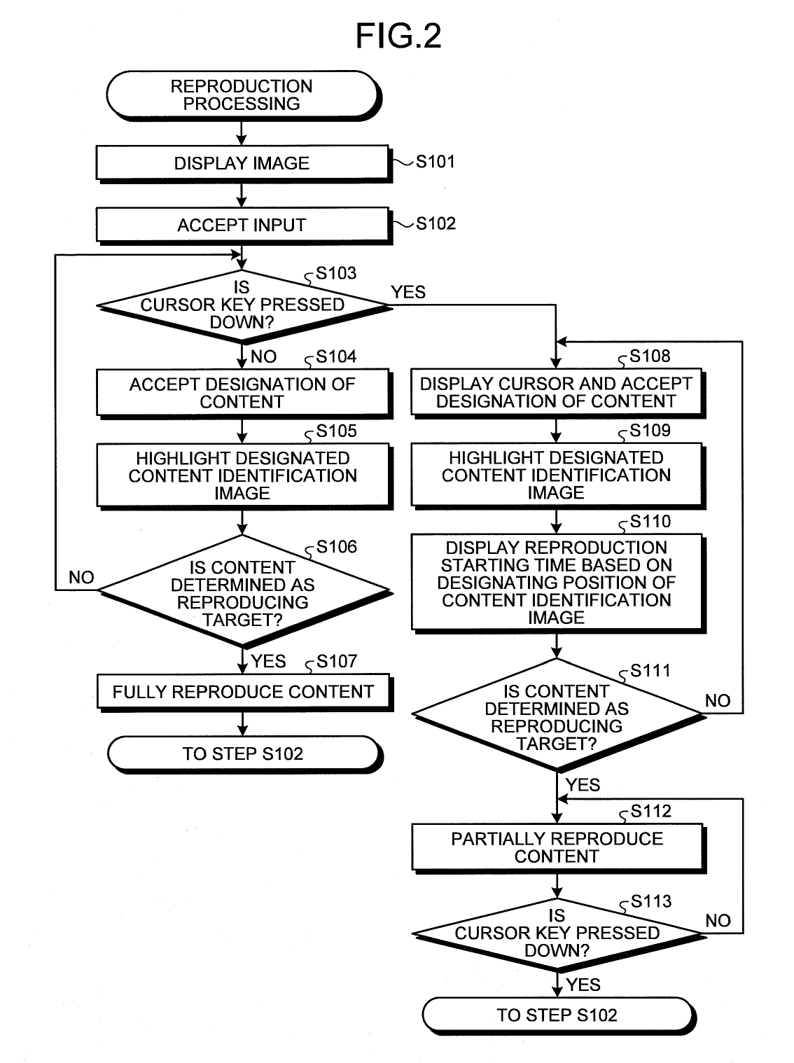

First of all, when a power supply of the reproducing apparatus 100 is turned ON, the reproducing apparatus 100 starts the reproduction processing illustrated in FIG. 2.

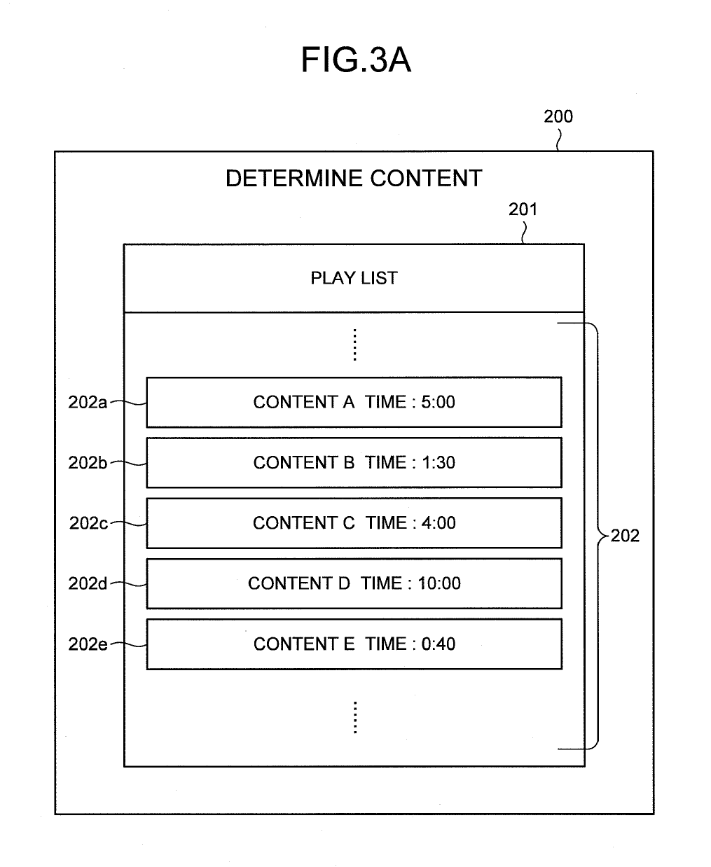

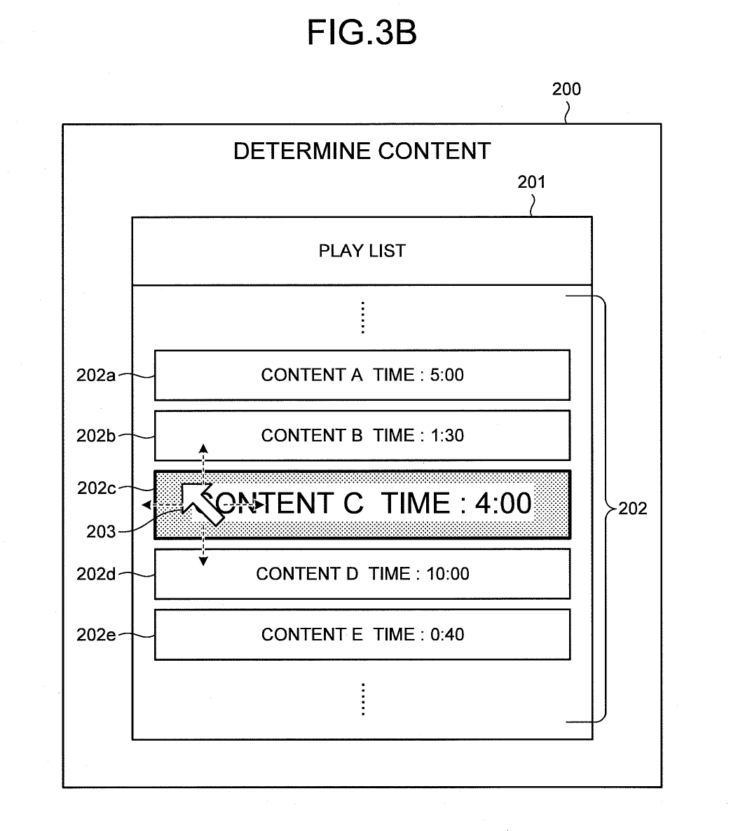

The control unit 110 controls the display unit 130, thereby displaying a screen 200 for determining, among from the plurality of contents, a content which is desired by a user as illustrated in FIG. 3A (Step S101). More specifically, the control unit 110 displays, on the screen 200, a play list 201 in which content identification images 202 of the plurality of contents are arranged in a list and the content identification images 202 (202a, 202b, 202c, 202d, 202e, . . . ) representing details of the content. A title of the each content (herein, a content A, a content B, . . . , a content E) and a recording time of the content (herein, a time: 5:00, a time: 1:30, . . . , a time: 0:40) are displayed on the content identification image 202 of each content. The user visually recognizes the title and the recording time for the content, thereby designating and determining a desired content from the plurality of contents.

Next, the control unit 110 controls the input unit 140 to accept an input from the user (Step S102). For example, the user operates the four-direction key (the cross key) provided in the input unit 140 to designate the content identification image 202 of the content from the play list 201. For example, in FIG. 3A, when the user presses down a down key, a content identification image 202a of the content A is designated. Further when the user presses down the down key, the content identification image 202b of the content B is designated. When the user sequentially presses down the key, the content identification image 202 to be designated is changed in the order of the content A, the content B, the content C, . . . . Moreover, the user presses down the cursor key provided in the input unit 140, thereby switching a reproducing mode (between a normal reproducing mode and a partial reproducing mode). The cursor key typically means a key for operating a cursor, that is, an arbitrarily selected key capable of displaying or not displaying the cursor. In addition, the normal reproducing mode means a mode for carrying out a full reproduction (a reproduction from beginning to end) of the content determined by the user, that is, a general mode for reproducing the content. The partial reproducing mode means a mode for reproducing a part of the content.

Next, the control unit 110 controls the input unit 140 to decide whether the cursor key provided in the input unit 140 is pressed down or not (Step S103). The producing mode for reproducing the content is decided based on whether the cursor key is pressed down or not.

When the cursor key is not pressed down (Step S103; No), the control unit 110 controls the input unit 140 and the display unit 130 to accept an input from the four-direction key (the cross key) provided in the input unit 140 in order to designate the content desired by the user (Step S104) and to highlight the content identification image 202 of the content designated by the user (Step S105). Consequently, the user can recognize which one of the contents (a content identification image) is being designated.

Subsequently, the control unit 110 controls the input unit 140 and the target determining unit 113 to decide whether the designated content is determined as the reproducing target or not (Step S106).

If the content is determined as the reproducing target (Step S106; Yes), the control unit 110 controls the reproduction control unit 114 to carry out a full reproduction of the content (Step S107). For example, in the case in which the content identification image 202c of the content C is highlighted, the full reproduction of the content C is carried out when the user presses down a key for prompting the reproduction. Then, the control unit 110 controls the input unit 140 to accept an input from the user (Step S102), thereby deciding whether the cursor key provided in the input unit 140 is pressed down or not (Step S103).

On the other hand, if the content is not determined as the reproducing target (Step S106; No), the processing returns to the step S103 in which the control unit 110 controls the input unit 140 to decide again whether the cursor key is pressed down or not. The normal reproducing mode for carrying out the full reproduction of the content is implemented in the processing of the Steps S104 to S107.

If the cursor key is pressed down at the Step S103 (Step S103; Yes), the control unit 110 controls the input unit 140 and the designation control unit 111 to display a cursor 203 as illustrated in FIG. 3B, thereby prompting the user to designate one content from the plurality of contents by using the cursor 203 to accept any one of the contents which is desired by the user (Step S108). The user visually recognizes the title or the recording time which is displayed on the content identification image 202 of the content that is shown over the play list 201, and at the same time, operates a key or a touch panel to move the cursor 203 in any arbitrary direction, that is, one of up, down, right, and left directions, thereby designating the content identification image 202 to arbitrarily select one content from the plurality of contents. When the cursor key is pressed down, the cursor 203 is displayed in an arbitrary position (for example, a position of a left end of the content identification image 202, a position set by the user, a last designated position, or the like).

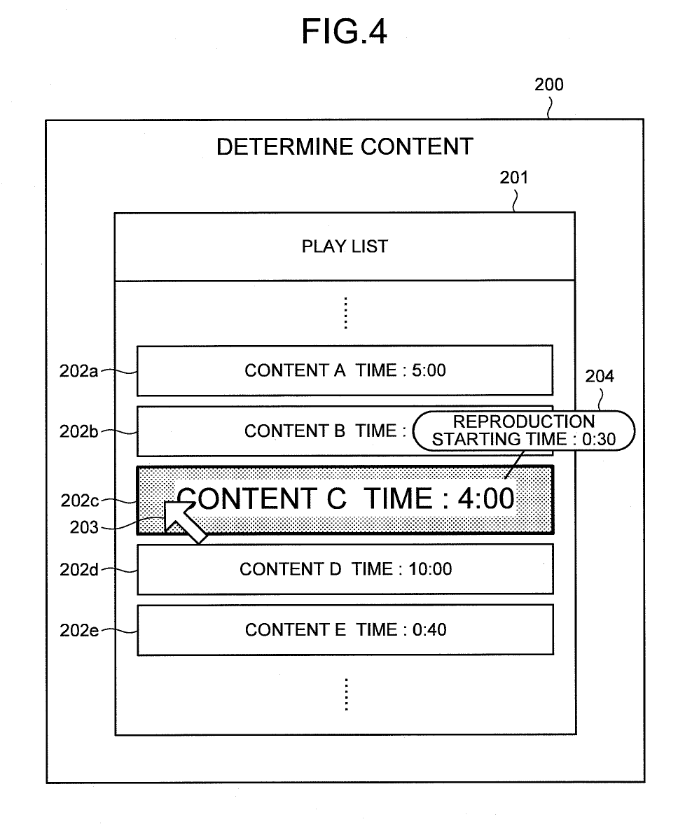

Subsequently, the control unit 110 controls the display unit 130, thereby highlighting the content identification image 202 of the designated content (Step S109). As illustrated in FIG. 4, the control unit 110 highlights the content identification image 202c of the content designated by the cursor 203 operated by the user, thereby clearly indicating, to the user, that the content C is designated (selected).

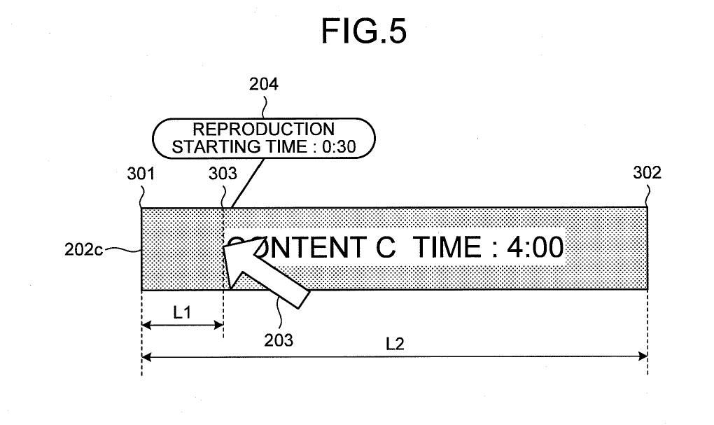

Next, the control unit 110 controls the position determining unit 112 to determine (derive) a position in which the partial reproduction of the content is started based on the designating position of the content identification image 202 of the content being designated by the cursor 203. Then, the control unit 110 controls the display unit 130 to display the reproduction starting time (Step S110). A method of deriving the reproducing starting time will now be described with reference to FIG. 5. In FIG. 5, the content identification image 202c of the content is designated through the cursor 203 operated by the user and the content (the content C) is selected. A starting position 301 and an ending position 302 which serve to determine the reproduction starting time are predetermined in the content identification image 202c of the content. The control unit 110 determines the reproduction starting time at which the partial reproduction of the content (the content C) is started based on a designating position 303 in which the cursor 203 designates the content identification image 202c of the content, the starting position 301, and the ending position 302. More specifically, when a recording time (a sound recording time) for the content is represented by a time Tr, a distance between the starting position 301 and the designating position 303 is represented by a distance L1, and a distance between the starting position 301 and the ending position 302 is represented by a distance L2, the reproduction starting time T is derived by the following Equation (1):

T=Tr×L1/L2 (1)

wherein the recording time Tr of the content (content C) is 4:00. Therefore, the control unit 110 multiplies a ratio (herein, 1/8) of the distance L1 to the distance L2 by the recording time Tr=4:00, thereby determining (deriving) the reproduction starting time T to be 0:30. Then, the control unit 110 displays the determined reproduction starting time T=0:30 as the reproduction starting time 204 over the screen 200.

Next, the control unit 110 controls the input unit 140 and the target determining unit 113 to decide whether the designated content is determined as the reproducing target and the reproduction starting time is determined or not (Step S111).

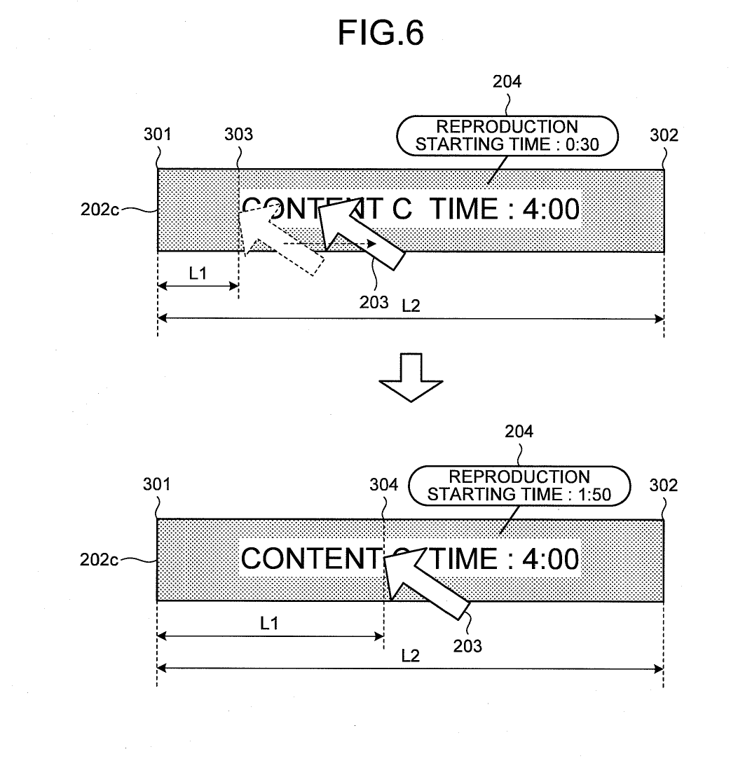

If the reproduction starting time is not determined (Step S111; No), the control unit 110 continuously displays the reproduction starting time 204 on the screen 200 and accepts the content desired by the user again (Step S108). Description will be given to a method of updating the reproduction starting time through moving the cursor 203 by a user in a state in which the content is not determined as the reproducing target. As illustrated in FIG. 6, when the cursor 203 moves in a rightward direction from the original designating position 303 and reaches a moving position 304, the distance L1 changes with the movement of the cursor 203. When the distance L1 changes a ratio of the distance L1 to the distance L2 also changes. Therefore, the reproduction starting time T derived from the Equation (1) also changes. The control unit 110 controls the position determining unit 112 and the display unit 130, thereby displaying, on the screen 200, the reproduction starting time T to be changed with the variation in the distance L1 as the reproduction starting time 204. For this reason, the reproduction starting time 204 to be displayed is also varied with the movement of the cursor 203. Consequently, it is possible to easily change the reproduction starting time at which the content is started to be partially reproduced. Therefore, it is possible to efficiently find out a content desired by the user from the plurality of contents.

On the other hand, if the content is determined as the reproducing target and the production starting time is determined (Step S111; Yes), the control unit 110 controls the reproduction control unit 114 to partially reproduce the information corresponding to the determined content for a predetermined period of time from the determined reproduction starting time T (Step S112). In the case of FIG. 4, the control unit 110 partially reproduces the information corresponding to the content (the content C) for a predetermined time (for example, 60 seconds) from the reproduction starting time of 0:30. Consequently, an arbitrarily selected content is partially reproduced from the reproduction starting time desired by the user, and the user hears the partial reproduction. Thus, it is possible to efficiently find out a desired one of the contents. A predetermined time for which the content is partially reproduced may be arbitrarily determined and could be, for example, a time which is predetermined by the user, the last reproducing time, a time which is equivalent to 10% of a whole time for the contents, or the like.

Next, the control unit 110 controls the input unit 140 to accept an input from the user, thereby deciding whether the cursor key is pressed down or not (Step S113). In some cases, the user may wish to partially reproduce a different content even in the middle of the partial reproduction because the content which is being partially reproduced is not desired by the user. Therefore, the control unit 110 decides whether the cursor key is pressed down or not (Step S113). If the cursor key is pressed down (Step S113; Yes), the processing returns to the screen 200 on which the play list 201, or the like is displayed and the input is accepted again (Step S102). Consequently, it is possible to designate and determine the content other than the contents being reproduced partially even in the middle of the partial reproduction. The partial reproducing mode for reproducing a part of the content is implemented in the processing of the Steps S108 to S113.

The control unit 110 can fully reproduce the designated content in an arbitrary timing, such as: while the content is partially reproduced; while the reproduction starting time is displayed; while the content identification image 202 of the content is highlighted; or the like. That is, the control unit 110 can fully reproduce the content by accepting a determination (a request) for switching from the partial reproducing mode to the normal reproducing mode. When accepting the determination for fully reproducing the content, the control unit 110 ends the partial reproduction processing for partially reproducing the content for a predetermined time from the reproduction starting time T, thereby executing the full reproduction processing for reproducing the content from beginning to end. When the user finds the desired content, thus, it is possible to fully reproduce the content immediately.

Moreover, in the case where the content is partially reproduced for a predetermined period of time from the reproduction starting time T and the other content is not designated even after the predetermined period of time passes, the control unit 110 can reproduce the partially reproduced content for the predetermined time from the reproduction starting time T again, that is, the control unit 110 can carry out what is called a loop reproduction. Furthermore, after reproducing a predetermined period of time t from the reproduction starting time, the control unit 110 can also reproduce the content for a predetermined additional time (t+ta) obtained by adding a predetermined additional time ta to the predetermined time t. Moreover, the control unit 110 can also reproduce the content fully from beginning to end by switching from the partial reproducing mode for the content to the normal reproducing mode. Consequently, even in the case where the user cannot grasp the content after hearing the partial reproduction of the content, the reproduction is further carried out so that the user can efficiently find out the desired content.

Based on the processing described above, an arbitrary content is designated from the plurality of contents, and the reproduction starting time at which the content is to be partially reproduced is easily changed, thereby enabling the user to hear the partial reproduction of the content. Consequently, it is possible for the user to efficiently find out the content desired by the user.

### Second Embodiment

Referring to the reproducing apparatus 100 according to the first embodiment, there has been described the method of easily changing a reproduction starting time at which a partial reproduction of a content is to be started. In the second embodiment, description will be given to a method of easily changing a reproducing time for which a content is partially reproduced. The description of the same structure and operation as those of the reproducing apparatus 100 according to the first embodiment will be properly omitted.

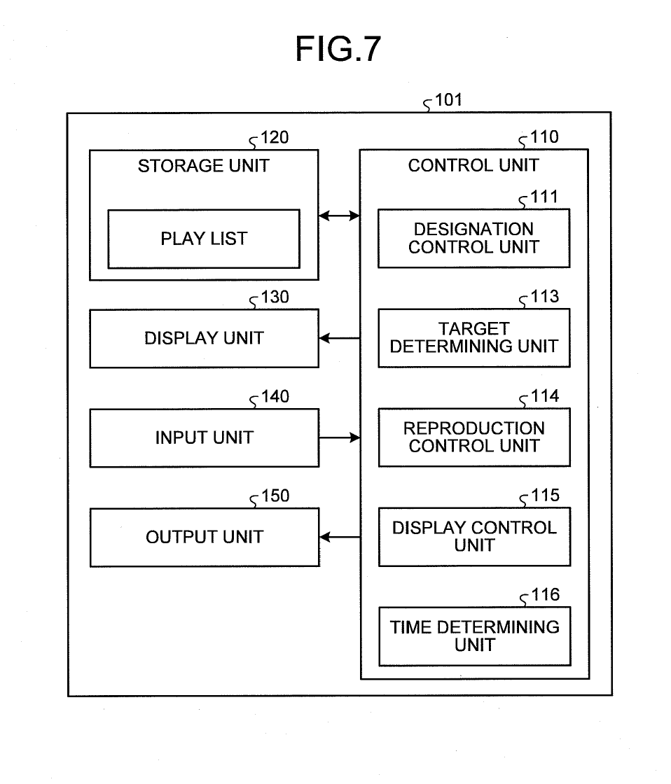

As illustrated in FIG. 7, a reproducing apparatus 101 according to the second embodiment includes: a control unit 110 having a designation control unit 111, a target determining unit 113, a reproduction control unit 114, a display control unit 115 and a time determining unit 116; a storage unit 120; a display unit 130; an input unit 140; and an output unit 150. Since the designation control unit 111, the target determining unit 113, the reproduction control unit 114, the display control unit 115, the storage unit 120, the display unit 130, the input unit 140 and the output unit 150 which are provided in the reproducing apparatus 101 are the same as those provided in the reproducing apparatus 100, description will not be repeated.

The time determining unit 116 determines a reproducing time in which the content designated by the designation control unit 111 is to be partially reproduced. A method of determining a reproduction time for partially reproducing the content will be described later.

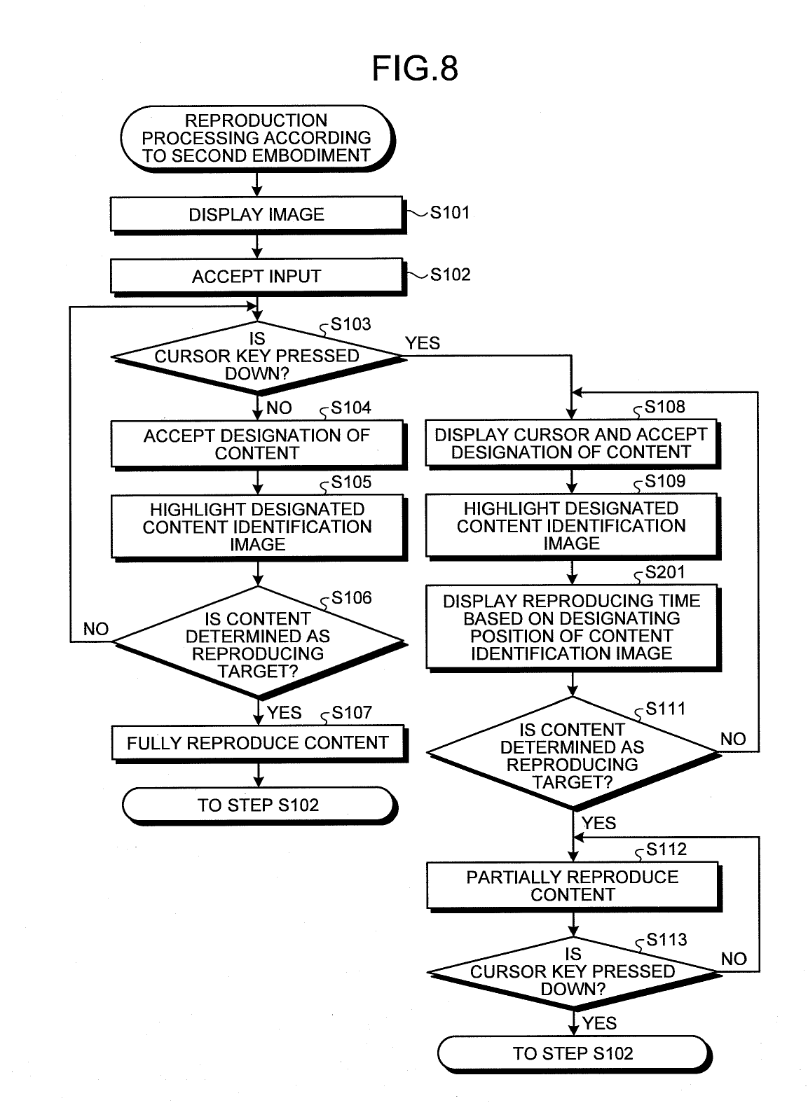

Next, a reproducing operation of the reproducing apparatus 101 according to the present embodiment will be described with reference to FIG. 8. Since processing in Steps S101 to S5109 and S111 to S113 according to the present embodiment have the same operations as those in the processing according to the first embodiment, description will not be repeated.

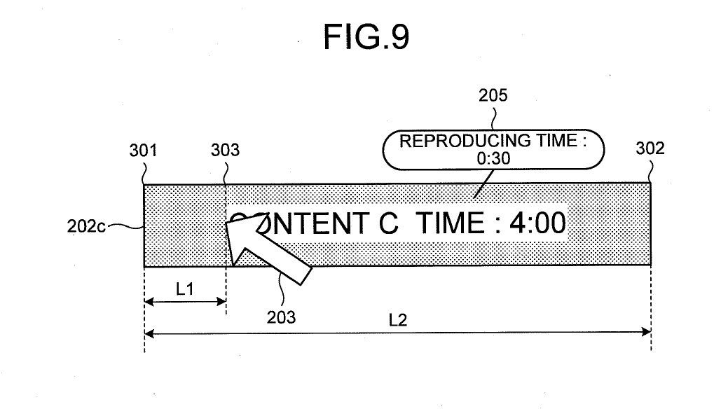

The control unit 110 controls the time determining unit 116 to determine (derive) a reproducing time for partially reproducing the content based on the designating position of the content identification image 202 of the content which is designated by a cursor 203. The control unit 110 controls the display unit 130 to display the reproducing time (Step S201). A method of deriving the reproducing time for partially reproducing a content will be described with reference to FIG. 9. In FIG. 9, content identification image 202c of the content is designated through the cursor 203 operated by the user and the content (the content C) is selected. A starting position 301 and an ending position 302 which serve to determine the reproducing time are predetermined in the content identification image 202c of the content. The control unit 110 determines a starting time for partially reproducing the content based on a designating position 303, in which the cursor 203 designates the content identification image 202c of the content, the starting position 301, and the ending position 302. More specifically, when a recording time (a sound recording time) for the content is represented by a time Tr, a distance between the starting position 301 and the designating position 303 is represented by a distance L1, and a distance between the starting position 301 and the ending position 302 is represented by a distance L2, a reproducing time Tp is derived by the following Equation (2):

Tp=Tr×L1/L2 (2)

wherein the recording time Tr of the content (content C) is 4:00. Therefore, the control unit 110 multiplies a ratio (herein, 1/8) of the distance L1 to the distance L2 by the recording time Tr=4:00, thereby determining (deriving) the reproducing time Tp to be 0:30. Then, the control unit 110 displays the determined reproducing time Tp=0:30 as the reproducing time 205 on the screen 200.

Next, if the content is determined as a reproducing target and the reproducing time is determined (step S111; Yes), the control unit 110 controls the position determining unit 112 and the reproduction control unit 114 to partially reproduce the content for only the reproducing time determined at the Step S201 (Step S112). In the case of FIG. 9, the control unit 110 partially reproduces a content corresponding to the content identification image 202c (content C) of the content from 0:00 to 0:30.

Based on the processing described above, an arbitrarily content is designated from the plurality of contents, and the reproduction starting time at which the content is to be partially reproduced is easily changed, thereby enabling the user to hear the partial reproduction of the content. Consequently, it is possible for the user to efficiently find out the content desired by the user.

The present invention is not limited to the embodiments described above but various modifications and applications can be made.

The content may be a TV program. When the content is the TV program, the control unit 110 displays a thumbnail as a content identification image 202 on the screen 200. The user operates the input unit 140 to instruct the thumbnail as the content identification image 202. The control unit 110 may only have to reproduce the content from a position of the instructed thumbnail.

The reproduction starting time T, and the starting position 301 and the ending position 302 which serve to determine the reproducing time Tp can be arbitrarily selected.

The method of displaying the content identification image 202 of the content can be arbitrarily selected. Moreover, a method of highlighting and displaying the content identification image 202 of the content can be arbitrarily selected. For example, it is also possible to display the content identification image 202 of the content by any method, for example, enlarging a display size of the content identification image 202 of the content, enlarging title characters of the content identification image 202 of the content, or changing a display shape of the content identification image 202 of the content (forming the content identification image 202 into a circular shape, a square shape, an elliptical shape, a star shape, or the like).

The reproduction starting time 204, as well as the display position, the display size and the display method of the reproducing time 205 can be arbitrarily selected.

Although the cursor 203 is used for designating and determining the content, the user can also set a position in which the user touches a touch panel as a designating position of the cursor 203.

In addition, the hardware structure and the flow chart are illustrative and can be arbitrarily changed and modified.

A main part for carrying out the processing of the reproducing apparatuses 100 and 101 which include the control unit 110, the storage unit 120, the display unit 130, the input unit 140 and the output unit 150 can be implemented by using an ordinary computer system in place of a dedicated system. For example, it is also possible to constitute the reproducing apparatuses 100 and 101 for executing the processing by storing and distributing a computer program for executing the operation in a computer readable recording medium (e.g. a flexible disc, a CD-ROM, a DVD-ROM) and installing the computer program in a computer. Moreover, it is also possible to constitute the reproducing apparatuses 100 and 101 by storing the computer program in a storage device possessed by a server device on a communication network, such as internet, and causing an ordinary computer system to download the computer program.

In the case where the function of the reproducing apparatus 100 is implemented by sharing an OS (operating system) and an application program or in cooperation of the OS and the application program, only the application program portion may be stored in a recording medium or a storage device.

In addition, it is also possible to superpose a computer program on a carrier wave and to deliver them through a communication network. For example, the computer program may be displayed on a bulletin board (BBS; Bulletin Board System) on the communication network and may be delivered through the network. Then, the computer program may be started up and executed in the same manner as the other application programs under a control of an OS, thereby carrying out the processing.

According to the present invention, a position (a place) in which the content information is partially reproduced is easily changed. Consequently, it is possible to efficiently find out the content desired by a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A reproducing apparatus comprising:
a storage unit configured to store information of each of a plurality of contents;
a display control unit configured to control to display, on a display unit, content identification images corresponding to the plurality of contents respectively;
a position determining unit configured to determine a reproducing position for the content based on a designating position for a display range of the content identification images which is designated when any one of the content identification image is designated; and
a reproduction control unit configured to reproduce the determined content from the determined reproducing position.

2. The reproducing apparatus according to claim 1, wherein
the reproduction control unit repetitively reproduces the determined content, for a predetermined time, from the determined reproducing position.

3. The reproducing apparatus according to claim 1, wherein
the reproduction control unit is configured to switch from the determined content to other content and reproduces the other content when the reproduction control unit receives a designation input for the other content during a reproduction of the determined content from the determined reproducing position.

4. A reproducing method comprising:
storing information of each of a plurality of contents;
controlling to display, on a display unit, content identification images corresponding to the plurality of contents respectively;
determining a reproducing position for the content based on a designating position for a display range of any one of the content identification images which is designated when the content identification image is designated; and
reproducing the determined content from the determined reproducing position.

5. A computer-readable recording medium that stores therein a computer program for outputting information, the computer program causing a computer to execute:
controlling to display, on a display unit, a content identification image corresponding to each of a plurality of contents;
determining a reproducing position for the content based on a designating position for a display range of any one of the content identification images which is designated when the content identification image is designated; and
reproducing the determined content from the determined reproducing position.
